(19) United States
(12) Patent Application Publication
(10) Pub. No.: US 2016/0092516 A1
(43) Pub. Date: Mar. 31, 2016

(54) METRIC TIME SERIES CORRELATION BY OUTLIER REMOVAL BASED ON MAXIMUM CONCENTRATION INTERVAL

(71) Applicant: ORACLE INTERNATIONAL CORPORATION, REDWOOD SHORES, CA (US)

(72) Inventors: THYAGARAJU POOLA, SUNNYVALE, CA (US); VLADIMIR VOLCHEGURSKY, REDWOOD CITY, CA (US)

(73) Assignee: ORACLE INTERNATIONAL CORPORATION, REDWOOD SHORES, CA (US)

(21) Appl. No.: 14/844,923

(22) Filed: Sep. 3, 2015

Related U.S. Application Data
(60) Provisional application No. 62/056,325, filed on Sep. 26, 2014.

(51) Int. Cl. G06F 17/30

(52) U.S. Cl. CPC G06F 17/30539; G06F 17/30377

(57) ABSTRACT

A correlation relationship between two metric time series is determined after removing the impact of outlying metric values (“outliers”) that are unimportant for analytical purposes. Each of the metric time series can represent values of different system metrics obtained by mining data gathered through the monitoring of cloud deployments. The outliers can be determined based on a maximum concentration interval of the data. Removing the impact of the outliers enhances the correlation of the metric time series and provides a better representation of the correlation relationship.

### CROSS-REFERENCE TO RELATED APPLICATIONS

The present application claims benefit under 35 USC 119(e) of U.S. Provisional Application No. 62/056,325, filed on Sep. 26, 2014 by Poola et. al. and entitled “Metric Time Series Correlation by Outlier Removal Based On Maximum Concentration Interval,” of which the entire disclosure is incorporated herein by reference for all purposes.

### BACKGROUND

Automated monitoring systems monitor information technology infrastructure along with complex software deployments, such as deployments within a cloud computing environment. The monitoring systems monitor the infrastructure and the deployments using metrics that represent the load, state, health, and behavior of each component in the infrastructure and each component of the software deployed in that infrastructure.

During normal operations of large deployments, error conditions can occur. These error conditions can affect the metrics. When information technology operations staff detect error conditions, the staff rectify the problems that produced the error conditions. After the staff have rectified the problems, the values of the metrics return to ranges that represent normal conditions.

For example, the usual time taken for a web page to display data queried from a database might be between 200 milliseconds and 300 milliseconds. This amount of time represents the normal response time for the web page. However, during times that the database is unavailable, perhaps due to the database system experiencing some error, this response time could decrease to just 20 milliseconds, as the web page relatively quickly returns an error instead of data queried from the database. After information technology operations staff repairs the error that affected the database, making the database available once again, the response time for the web page might return to the normal range of between 200 milliseconds and 300 milliseconds.

A monitoring system that measures the response time as a metric can gather data that represents the values of the metric over a time interval—a metric time series. Within a time interval that includes a period during which the database was unavailable due to an error, as discussed in the example above, the unusually low metric value of 20 milliseconds occuring within that period is an outlying value (an “outlier”). The outlier falls considerably outside of the normal range of 200 to 300 milliseconds for that particular metric.

Outliers can occur within a metric time series due to errors or other problems influencing hardware systems and/or the software systems that execute upon those hardware systems. Error conditions could occur for a variety of reasons, including, for example, software bugs, malformed user input, network glitches, and other intermittent issues.

The discovery of a correlation between two metric time series can be useful for analyzing the ways in which different subsystems of a deployment influence each other. Industry-standard algorithms, such as the Spearman correlation algorithm and the Pearson correlation algorithm, can be used to determine a correlation relationship between two metric time series. However, if one or both metric time series contain outlying values that represent abnormal behavior, such as error conditions, then the correlation coefficient produced by these algorithms could be significantly impacted by these outliers. The outliers can cause the algorithms to produce a lower correlation coefficient, indicative of a lesser degree of correlation between the metric time series, than the algorithms might have produced if the metric time series had only included values that represented normal operating conditions.

As a result, analysts studying correlations between different subsystems in a cloud deployment may incorrectly conclude that one subsystem does not influence another subsystem.

### BRIEF SUMMARY

According to some embodiments, a correlation relationship between a pair of metric time series is determined after removing the impact of outlying metric values (“outliers”) that are unimportant for analytical purposes. Each of the metric time series can represent values of different system metrics obtained by mining data gathered through the monitoring of cloud deployments. The outliers can be determined based on a maximum concentration interval of the data. Removing the impact of the outliers enhances the correlation of the metric time series and provides a better representation of the correlation relationship.

Techniques described herein can determine, for various subsystems, metric values that represent the general behaviors of those subsystems during a time interval. The techniques can exclude, from the metric time series for those subsystems, data points falling outside of the normal range of the subsystems' general behavior prior to determining a correlation between the metric time series. The techniques can be performed for subsystems of any kind and their constituent components. The techniques can use a maximum concentration interval of metric values to determine values that are outliers.

Techniques described herein can remove outliers from metric time series prior to the assessment of a correlation between those metric time series. Consequently, such techniques allow any of several different correlation algorithms to be used to determine the correlation. Correlation algorithms can be chosen based on types of relationships, such as linear relation, non-linear relation, monotonic, etc. Values in a metric time series can be considered independently.

Beneficially, techniques described herein can be performed relative to metric time series that include values that might not have been sampled at regular time intervals. Additionally, techniques described herein can be performed even without any pre-existing knowledge of any monitored subsystem's problems. Techniques described herein can be applied generically, and agnostically to the specific nature of systems' behaviors and problems.

### BRIEF DESCRIPTION OF THE DRAWINGS

FIG. 1 is a flow diagram that illustrates a technique for comparing correlations between a pair of metric time series with and without outliers, according to some embodiments.

FIG. 2 is a flow diagram that illustrates a technique for removing outliers from a metric time series, according to some embodiments.

FIG. 3 is a diagram that illustrates an example of multiple point intervals occuring within a metric time series in which points have been sorted by their associated values, according to some embodiments.

FIG. 4 is a diagram that illustrates an example of aligning a pair of metric time series along a timeline, according to some embodiments.

FIG. 5 depicts a simplified diagram of a distributed system for implementing one of the embodiments.

FIG. 6 is a simplified block diagram of components of a system environment by which services provided by the components of an embodiment system may be offered as cloud services, in accordance with an embodiment of the present disclosure.

FIG. 7 illustrates an example of a computer system in which various embodiments of the present invention may be implemented.

### DETAILED DESCRIPTION

In the following description, for the purposes of explanation, specific details are set forth in order to provide a thorough understanding of embodiments of the invention. However, it will be apparent that various embodiments may be practiced without these specific details. The figures and description are not intended to be restrictive.

Systems depicted in some of the figures may be provided in various configurations. In some embodiments, the systems may be configured as a distributed system where one or more components of the system are distributed across one or more networks in a cloud computing system.

Monitoring Subsystems within a Cloud Deployment

A cloud computing environment can include a network of hardware servers, or nodes, on which various different cloud service customers' software application instances can be deployed. For example, each node can execute cloud computing host software that configures the node to be an participant in the cloud computing environment. Application instances of a customer's choice, and potentially of the customer's own creation, can be distributed among and executed by a collection of Oracle WebLogic servers executing on such nodes. The use of computing resources of a cloud computing environment can be concurrently shared among multiple unrelated customers because the cloud computing host software executing on the nodes enforces isolation between each separate customer's instances and associated data. Such sharing helps to maximize the utilization of computing resources, which theoretically decreases the cost of usage for each user.

Because a cloud computing environment can be vast, and because the quantity of nodes within that environment can be enormous, the task of ensuring that subsystems of application instances deployed in the environment are functioning properly can become complicated. In order to ease the task of shepherding these subsystems, a cloud computing environment can include automated monitoring systems. These monitoring systems can poll or sample various components of various subsystems in order to measure aspects such as load (e.g., utilization), state (e.g., active or shutdown), health, behavior (e.g., performance or response time), or other specified aspect or attribute. Oracle Enterprise Manager is an example of a monitoring system. Enterprise Manager can exist as a service within a cloud computing environment, so that multiple unrelated customers can concurrently use its monitoring facilities in a shared manner relative to their own deployments within the environment.

Enterprise Manager includes different kinds of monitoring systems designed to monitor different kinds of subsystems. For example, one such monitoring system can be specifically designed to monitor a middleware subsystem, while another such monitoring system can be specifically designed to monitor a database subsystem. Each monitoring system can be configured to gather data relating to an associated monitored subsystem in real-time. Each monitoring system can continuously store this gathered data as a metric time series. Metric time series are discussed in further detail below.

As is mentioned above, the vastness of a deployment within a cloud computing environment can make it even more difficult to detect errors affecting that deployment. One approach for detecting errors involves discovering correlations between the metric time series of separate subsystems within a deployment. Because the interrelationship between these subsystems might not be obvious, a strong correlation discovered between the metric time series recorded for those subsystems can reveal how events occuring in one subsystem might be leading to problems occurring in another subsystem. Although certain embodiments described herein pertain to cloud computing environments, embodiments are not limited to that context; embodiments can be implemented within any enterprise computing environment. In some embodiments, a customer's own enterprise computing environment generates events. These events then are then uploaded to a cloud computing environment operated by an organization separate from the customer's. These events can be evaluated by software executing within the cloud computing environment.

Outliers within Metric Time Series

According to some embodiments, correlations between pairs of metric time series from which outliers have been removed can be computed. A metric time series is a series of points, each having an associated value and timestamp. The points within the metric time series are ordered based on their associated timestamps. Within a metric time series, a particular value can (and probably will) occur multiple times in separate points associated with different timestamps.

When the values of the points are measurements of an aspect or attribute of some component of some subsystem of a cloud deployment, some of the values can fall outside of the range of values that are normally encountered when that subsystem or its component is behaving normally—while not experiencing any error condition. These values falling outside of this range, and the points with which those values are associated, are outliers.

An example of a scenario in which outliers might likely occur follows. When a computing device initially starts up after being powered on, its central processing unit typically has an unusually high utilization. This is because the computing device's operating system is loading code from storage into memory and executing that code as processes needed to allow the computing device to operate. After this code has been loaded and executed, the utilization of the central processing unit can decline dramatically to a lower, relatively steady-state level. Barring any errors or atypical events, the utilization is likely to remain close to this level. In this scenario, the values of the utilization (a metric) of the central processing unit measured during the boot procedure are outliers in a time frame that includes a long interval following the boot procedure.

Outliers can detrimentally impact the accuracy of a correlation between pairs of metric time series. Techniques described herein automatically identify and remove outliers from metric time series in order to increase the accuracy of correlations between pairs of metric time series.

Comparison of Correllations with and without Outliers

According to some embodiments, two correlations are computed: a correlation between two metric time series from which outliers have been removed, and another correlation between those metric time series from which the outliers have not been removed. The correlation coefficients for each such correlation can be then computed, and the correlation coefficients can be compared in order to ascertain an influence that the outliers have upon the correlation between the two metric time series.

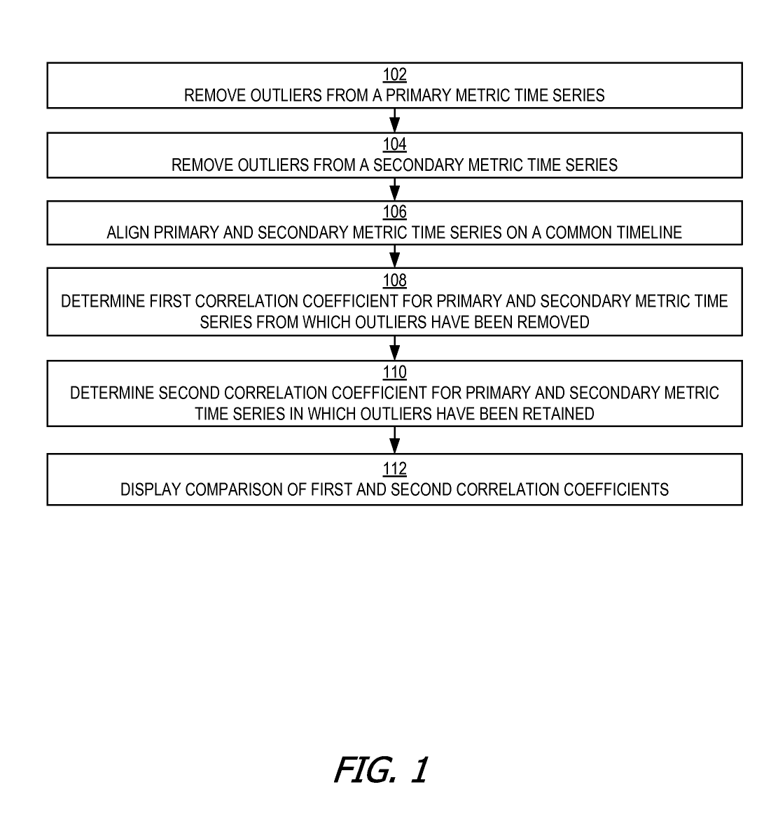

FIG. 1 is a flow diagram that illustrates a technique for comparing correlations between a pair of metric time series with and without outliers, according to some embodiments. Although FIG. 1 illustrates operations being performed in a specific order, alternative embodiments can involve additional or fewer operations being performed in the same or in different orders. The technique illustrated in FIG. 1 can be performed by a process executing on a computing device, for example.

In block 102, outliers are removed from a primary metric time series. The primary metric time series can be a series of points associated with values measured for a component of a first subsystem of a cloud deployment over a specified time interval, for example. The first subsystem, and the component thereof, can be selected by a user. The measurements can pertain to a load, state, health, behavior, or other specified aspect or attribute of the component, for example. The values can be obtained from an automated monitoring system that can poll or sample the component periodically or in response to the occurrence of specified events. Additional details about techniques for removing outliers from a metric time series are discussed further below. A version of the primary metric time series from which outliers have not been removed can be retained for use in block 110.

In block 104, outliers are removed from a secondary metric time series. Like the primary metric time series, the secondary metric time series can be a series of points associated with values measured for a component of a subsystem of a cloud deployment over a specified time interval. However, the values of the points within the secondary metric time series can be measured from a component of a second, separate subsystem of the cloud deployment over the specified time interval. The second subsystem, and the component thereof, also can be selected by a user. As with the primary metric time series, the measurements can pertain to a load, state, health, behavior, or other specified aspect or attribute of the component. The aspects or attributes measured in the values associated with the points of primary and second metric time series can differ or they can be the same. As with the primary metric time series, the values associated with the points in the secondary metric time series can be obtained from an automated monitoring system. A version of the secondary metric time series from which outliers have not been removed can be retained for use in block 110.

Although the primary and secondary metric time series can contain points associated with values measured by monitoring systems over a long time period, these metric time series do not necessarily contain points for all values ever measured by those monitoring systems. In some embodiments, the compositions of the primary and secondary metric time series can be constrained by user-specified parameters, such as a starting time and an ending time. In such a scenario, the primary and secondary metric time series for which a correlation coefficient is to be computed can be constrained to include only those points that are associated with timestamps that fall within the time window specified by the user.

In block 106, the primary and secondary metric time series (from which outliers have been removed in blocks 102 and 104) are aligned on a common timeline. The timeline can span the time interval in which the primary and secondary metric time series both specify at least some points. The timeline can be segmented into time units. The primary metric time series, the secondary metric time series, both metric time series, or neither metric time series might specify points corresponding to (e.g., having values measured at a moment associated with) various time units within the timeline. This phenomenon can occur due to different monitoring systems measuring different components at different frequencies, for example, or because an outlier was removed from a metric time series (creating a “hole”).

According to some embodiments, unless both the primary metric time series and the secondary metric time series include points for a particular time unit, the points (and associated values) that either metric time series includes for the particular time unit are removed from that metric time series for purposes of the technique illustrated in FIG. 1 (the points and their associated values can be retained in a separate version of that metric time series for different purposes). Such removal can be performed relative to all time units within the timeline for which fewer than both of the metric time series specifies a point.

According to some embodiments, each time unit of the time units into which the timeline is segmented can be a “bucket” that can contain multiple separate points and associated values. For example, if the moments to which multiple separate points within the same metric time series correspond all occur within a particular bucket's time range, then those points can be aggregated into a single representative point for that particular bucket. The value of the representative point can be determined by averaging the values of all of the bucket's points, for example.

In block 108, a first correlation coefficient for the primary and secondary metric time series from which outliers have been removed is determined. The first correlation coefficient can be determined based on versions of the primary and secondary metric time series from which non-aligned points and their associated values have been removed, as discussed above in connection with block 106. A variety of different techniques can be used to determine the first correlation coefficient. For example, the Spearman or Pearson algorithms, or linear regression models can be used to determine the first correlation coefficient.

In some embodiments, the first correlation coefficient can be stored in association with the primary metric time series and the secondary metric time series. A computing device can access the first correlation coefficient to quantify a possible relationship between the primary metric time series and the secondary metric time series. A computing device can cause the first correlation coefficient to be displayed in response to a request to quantify a possible relationship between the primary metric time series and the secondary metric time series.

In block 110, a second correlation coefficient for the primary and secondary metric time series in which outliers have been retained is determined. Although the outliers are retained, the second correlation coefficient can also be determined based on versions of the primary and secondary metric time series from which non-aligned points and their associated values have been removed, as discussed above in connection with block 106. In this case, however, non-alignment would not result from the removal of any outlier. As with the first correlation coefficient, a variety of different techniques can be used to determine the second correlation coefficient.

In block 112, a comparison of the first and second correlation coefficients is displayed. For example, numerical values for the correlation coefficients can be displayed. Additionally or alternatively, graphical representations of the directions and magnitudes of the correlations represented by the correlation coefficients can be displayed. For example, ellipses tilted based on whether a correlation is positive or inverse, and having minor axes whose lengths are based on a magnitude of a correlation, can be displayed for each of the correlation coefficients. In this manner, an analyst can visualize the influence that outliers have upon a correlation between the primary and metric time series.

Removing Outliers from a Metric Time Series

As is discussed above, in some embodiments, outliers are removed from primary and secondary metric time series before a correlation coefficient for that pair of metric time series is computed, so that the correlation between the pair of metric time series uncorrupted by the outliers can be ascertained. In some embodiments, outliers are defined as a metric time series' points having associated values that fall outside of a range bounded by certain lower and upper thresholds. The range represents the “baseline” of expected values in a normal operational scenario. An example of expected values can be considered in a physiological context: a healthy human being is expected to have blood pressure measurements occuring within a specified numerical range.

In such embodiments, the range represents the maximum concentration interval of a particular metric time series' data (i.e., all of its points) in which at least a specified percentage p of that data occurs. In some embodiments, p is set to 90% by default, although different embodiments can use different percentages for p. If p is 90%, then points associated with values that fall outside of the range in which 90% of the particular metric time series' values occur are considered to be outliers within that particular metric time series.

Because different metric time series can contain points having values falling into different ranges, the lower and upper thresholds for the maximum concentration intervals of different metric time series can also differ. In order to remove outliers from a metric time series, the maximum concentration interval for that metric time series is determined, using techniques described below.

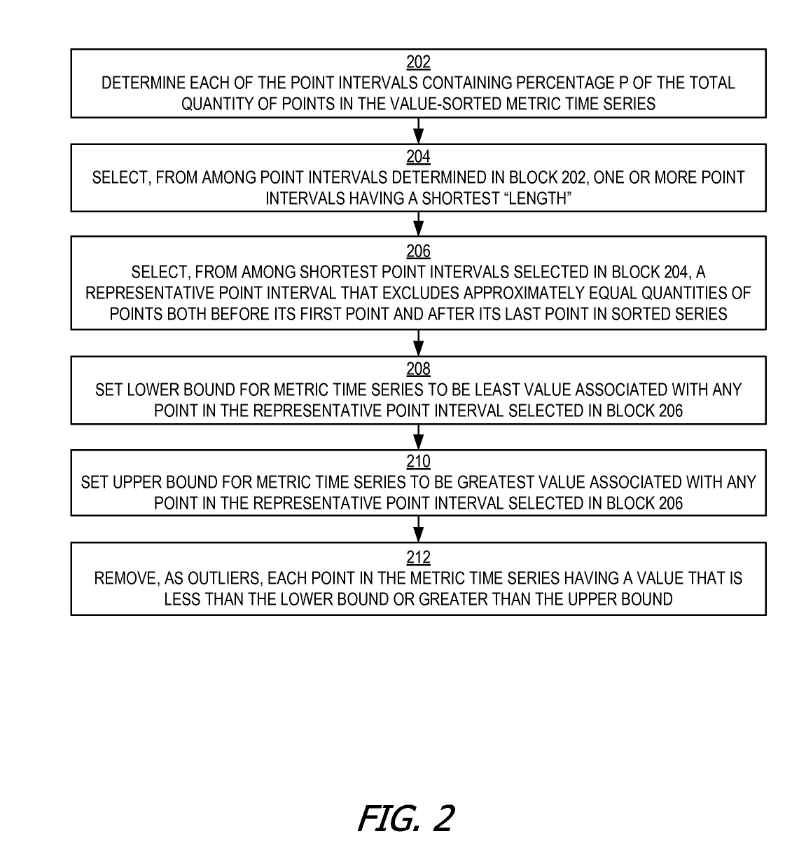

FIG. 2 is a flow diagram that illustrates a technique for removing outliers from a metric time series, according to some embodiments. Although FIG. 2 illustrates operations being performed in a specific order, alternative embodiments can involve additional or fewer operations being performed in the same or in different orders. The technique illustrated in FIG. 2 can be performed by a process executing on a computing device, for example. The technique illustrated in FIG. 2 can be performed as part of the operations of blocks 102 and 104 of FIG. 1.

Point intervals are discussed in FIG. 2. A point interval is a set of points from a metric time series in which the points have been sorted by their associated values, from least to greatest (as mentioned above, usually in a metric time series, points occur in timestamp order). A point interval includes a specified quantity of adjacent (in the sorted list) points from the metric time series sorted in this manner. For example, the specified quantity of points within a point interval can be based on percentage p; if there are 1000 points in a metric time series, and if p is 90%, then the point interval will contain 900 points. Multiple different point intervals can occur within a particular metric time series.

In block 202, each of the point intervals containing percentage p of the total quantity of points in the metric time series are determined. Although these point intervals each contain the same quantity of points, these point intervals each can contain different points from the metric time series.

In block 204, from among the point intervals determined in block 202, one or more point intervals having a shortest “length” of the point intervals determined in block 202 are selected. The “length” of a point interval is defined as the difference between (a) the greatest value associated with any point in that point interval and (b) the least value associated with any point in that point interval. Thus, for example, if the greatest value associated with any point in a particular point interval is 75, and if the least value associated with any point in that particular point interval is 25, then the “length” of that point interval is 75−25=50.

In block 206, from among the shortest point intervals selected in block 204, a representative point interval that excludes approximately equal quantities of points both before its first point and after its last point is selected. This representative point interval is associated with the most robust estimate that approximately half of outliers will occur outside each of the boundaries (upper and lower) of the range of values encompassed by the representative point interval.

For example, given two point intervals of the same “length,” a point interval that follows approximately 5% and precedes approximately 5% of the points in the metric time series can be selected over a point interval that follows approximately 2% and precedes approximately 8% of the points in the metric time series (assuming a percentage p of 90%). Thus, from among the shortest point intervals selected in block 204, a point interval occurring closest to the center of the value-sorted metric time series can be chosen as the representative point interval.

In block 208, a lower bound for the metric time series is set to be the least value associated with any point in the representative point interval selected in block 206. In the example of the particular point interval set forth in connection with block 204 above, the lower bound would be 25.

In block 210, an upper bound for the metric time series is set to be the greatest value associated with any point in the representative point interval selected in block 206. In the example of the particular point interval set forth in connection with block 204 above, the upper bound would be 75.

In block 212, for each point in the metric time series having an associated value that is either (a) less than the lower bound determined in block 208 or (b) greater than the upper bound determined in block 210, that point and its associated value are removed, as being an outlier, from the metric time series.

### Example Point Intervals

As is discussed above, in some embodiments, the points in a metric time series are sorted by their associated values (rather than their associated timestamps), after which multiple point intervals containing at least a specified percentage p of the points in the metric time series are determined.

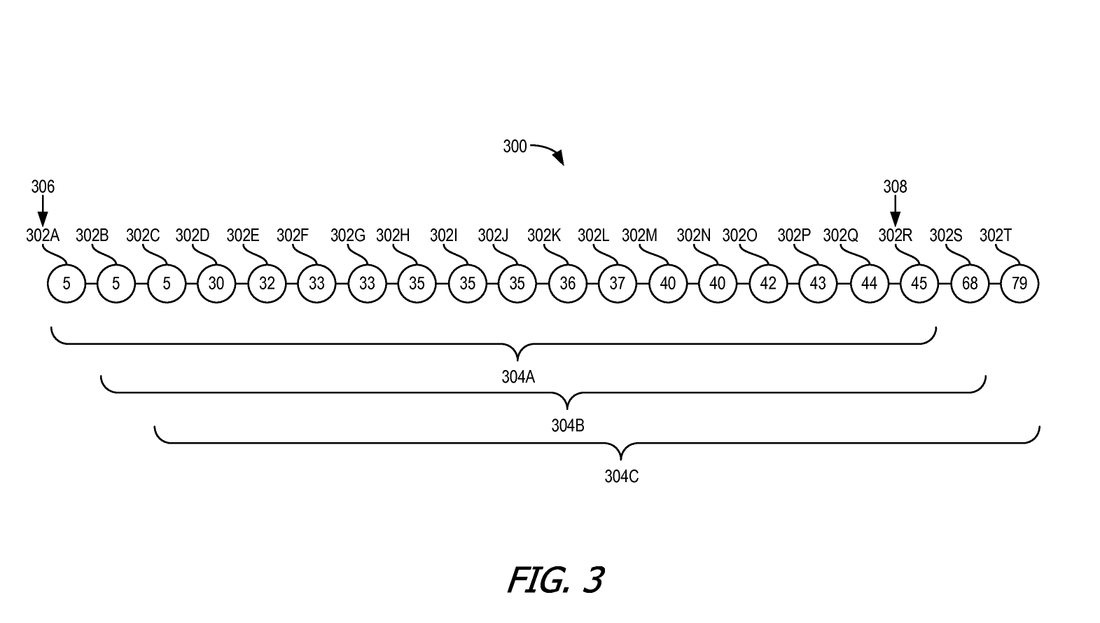

FIG. 3 is a diagram that illustrates an example of multiple point intervals occuring within a metric time series in which points have been sorted by their associated values, according to some embodiments. For reasons of simplicity, the timestamps associated with the points are not shown.

In FIG. 3, value-sorted metric time series 300 includes 20 points 302A-302T. Assuming that percentage p is 90%, each point interval determined from value-sorted metric time series 300 contains 18 of the 20 points. A point interval 304A includes points 302A-302R. A point interval 304B includes points 302B-302S. A point interval 304C includes points 302C-302T.

The least and greatest values of points in point interval 304A are the values of points 302A (5) and 302R (45), respectively. Therefore, the “length” of point interval 304A is 45−5=40.

The least and greatest values of points in point interval 304B are the values of points 302B (5) and 302S (68), respectively. Therefore, the “length” of point interval 304B is 68−5=63.

The least and greatest values of points in point interval 304C are the values of points 302C (8) and 302T (79), respectively. Therefore, the “length” of point interval 304C is 79−8=71.

Thus, the shortest point interval of point intervals 304A-C is point interval 304A. In this example, point interval 304A would be selected as the representative point interval for metric time series 300, since it is the only point interval having the shortest length (40).

The lower bound 306 of point interval 304A is the value of point 302A (5). The upper bound 308 of point interval 304A is the value of point 302R (45). Therefore, any of points 302A-T having values less than 5 or greater than 45 will be excluded from metric time series 300 as outliers. In this simplified example, only points 302S (value 68>45) and 302T (value 79>45) are excluded as outliers. Although points 302S and 302T are adjacent within value-sorted metric time series 300, the timestamps associated with points 302S and 302T might reveal that they do not necessarily occur close in time to each other.

### Example Timeline Alignment

As is discussed above, in some embodiments, after outliers have been removed from each of a pair of metric time series, those metric time series are aligned along a timeline, and points from either metric time series that do not have a corresponding point from the other metric time series in the same time unit are removed from that metric time series.

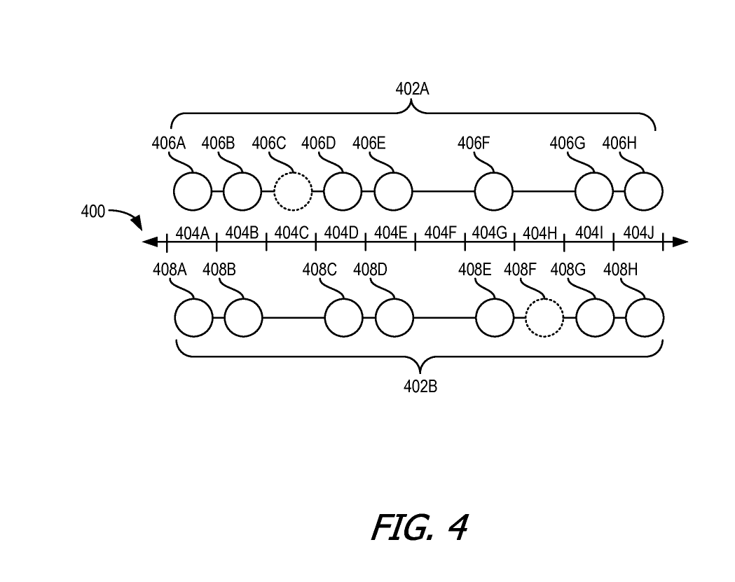

FIG. 4 is a diagram that illustrates an example of aligning a pair of metric time series along a timeline, according to some embodiments. A metric time series 402A is aligned along a timeline 400 with a metric time series 402B. Timeline 400 is segmented into time units 404A-J. The points in metric time series 402A and 402B are sorted, as usual, in order of their associated timestamps.

Metric time series 402A includes points 406A-H. Metric time series 402B includes points 408A-H. However, not all of points 406A-H are aligned with points 408A-H within time units 404A-J. In time unit 404C, metric time series 402A contains point 406C, but there is no corresponding point in time unit 404C from metric time series 402B. Therefore, point 406C is removed from metric time series 402A. Conversely, in time unit 404H, metric time series 402B contains point 408F, but there is no corresponding point in time unit 404H from metric time series 402A. Therefore, point 408F is removed from metric time series 402B. No points from either of metric time series 402A-B have timestamps falling into time unit 404F.

### Outlier Analysis

As is discussed above, in some embodiments, the removal of outliers from metric time series can produce a more accurate correlation coefficient. In some embodiments, the detection of the outliers can serve other purposes. For example, in some embodiments, after the outliers in a metric time series have been determined using techniques described above, those outliers, as well as characteristics of those outliers, can be displayed. An analyst can use such characteristics to discern qualities shared by the outliers, which can explain apparent anomalous values.

For example, a set of outliers from a metric time series that contains points having values representing end-to-end request-to-response times between end user devices and web servers in the cloud computing environment (or any enterprise computing environment) might all be associated with unusually high response time values. However, if the requests associated with these outlying high response time values are determined to originate collectively from some geographical location that is very remote with very limited communication infrastructure, then this fact can explain why the outliers occurred. Such explanation can inspire a monitoring service adminstrator to configure a monitoring system to flag or treat differently points having certain qualities.

### Hardware Overview

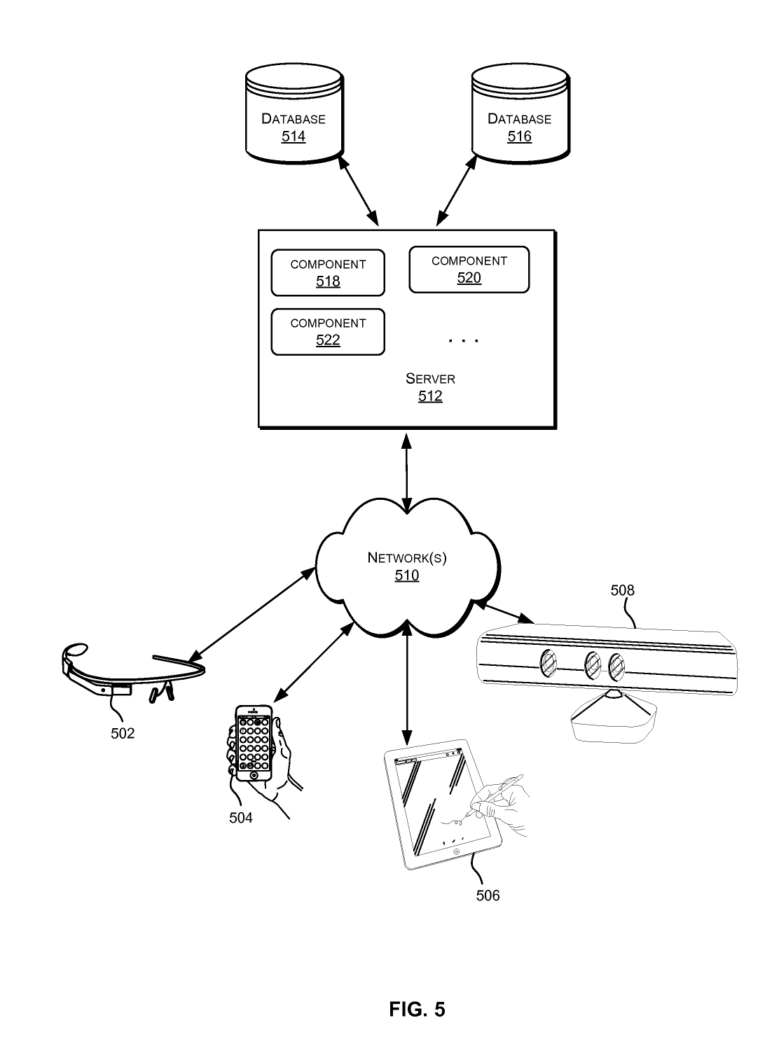

FIG. 5 depicts a simplified diagram of a distributed system 500 for implementing one of the embodiments. In the illustrated embodiment, distributed system 500 includes one or more client computing devices 502, 504, 506, and 508, which are configured to execute and operate a client application such as a web browser, proprietary client (e.g., Oracle Forms), or the like over one or more network(s) 510. Server 512 may be communicatively coupled with remote client computing devices 502, 504, 506, and 508 via network 510.

In various embodiments, server 512 may be adapted to run one or more services or software applications provided by one or more of the components of the system. In some embodiments, these services may be offered as web-based or cloud services or under a Software as a Service (SaaS) model to the users of client computing devices 502, 504, 506, and/or 508. Users operating client computing devices 502, 504, 506, and/or 508 may in turn utilize one or more client applications to interact with server 512 to utilize the services provided by these components.

In the configuration depicted in the figure, the software components 518, 520 and 522 of system 500 are shown as being implemented on server 512. In other embodiments, one or more of the components of system 500 and/or the services provided by these components may also be implemented by one or more of the client computing devices 502, 504, 506, and/or 508. Users operating the client computing devices may then utilize one or more client applications to use the services provided by these components. These components may be implemented in hardware, firmware, software, or combinations thereof. It should be appreciated that various different system configurations are possible, which may be different from distributed system 500. The embodiment shown in the figure is thus one example of a distributed system for implementing an embodiment system and is not intended to be limiting.

Client computing devices 502, 504, 506, and/or 508 may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry, Palm OS, and the like, and being Internet, e-mail, short message service (SMS), Blackberry®, or other communication protocol enabled. The client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices 502, 504, 506, and 508 may be any other electronic device, such as a thin-client computer, an Internet-enabled gaming system (e.g., a Microsoft Xbox gaming console with or without a Kinect® gesture input device), and/or a personal messaging device, capable of communicating over network(s) 510.

Although exemplary distributed system 500 is shown with four client computing devices, any number of client computing devices may be supported. Other devices, such as devices with sensors, etc., may interact with server 512.

Network(s) 510 in distributed system 500 may be any type of network familiar to those skilled in the art that can support data communications using any of a variety of commercially-available protocols, including without limitation TCP/IP (transmission control protocol/Internet protocol), SNA (systems network architecture), IPX (Internet packet exchange), AppleTalk, and the like. Merely by way of example, network(s) 510 can be a local area network (LAN), such as one based on Ethernet, Token-Ring and/or the like. Network(s) 510 can be a wide-area network and the Internet. It can include a virtual network, including without limitation a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol); and/or any combination of these and/or other networks.

Server 512 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In various embodiments, server 512 may be adapted to run one or more services or software applications described in the foregoing disclosure. For example, server 512 may correspond to a server for performing processing described above according to an embodiment of the present disclosure.

Server 512 may run an operating system including any of those discussed above, as well as any commercially available server operating system. Server 512 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle, Microsoft, Sybase, IBM (International Business Machines), and the like.

In some implementations, server 512 may include one or more applications to analyze and consolidate data feeds and/or event updates received from users of client computing devices 502, 504, 506, and 508. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 512 may also include one or more applications to display the data feeds and/or real-time events via one or more display devices of client computing devices 502, 504, 506, and 508.

Distributed system 500 may also include one or more databases 514 and 516. Databases 514 and 516 may reside in a variety of locations. By way of example, one or more of databases 514 and 516 may reside on a non-transitory storage medium local to (and/or resident in) server 512. Alternatively, databases 514 and 516 may be remote from server 512 and in communication with server 512 via a network-based or dedicated connection. In one set of embodiments, databases 514 and 516 may reside in a storage-area network (SAN). Similarly, any necessary files for performing the functions attributed to server 512 may be stored locally on server 512 and/or remotely, as appropriate. In one set of embodiments, databases 514 and 516 may include relational databases, such as databases provided by Oracle, which are adapted to store, update, and retrieve data in response to SQL-formatted commands.

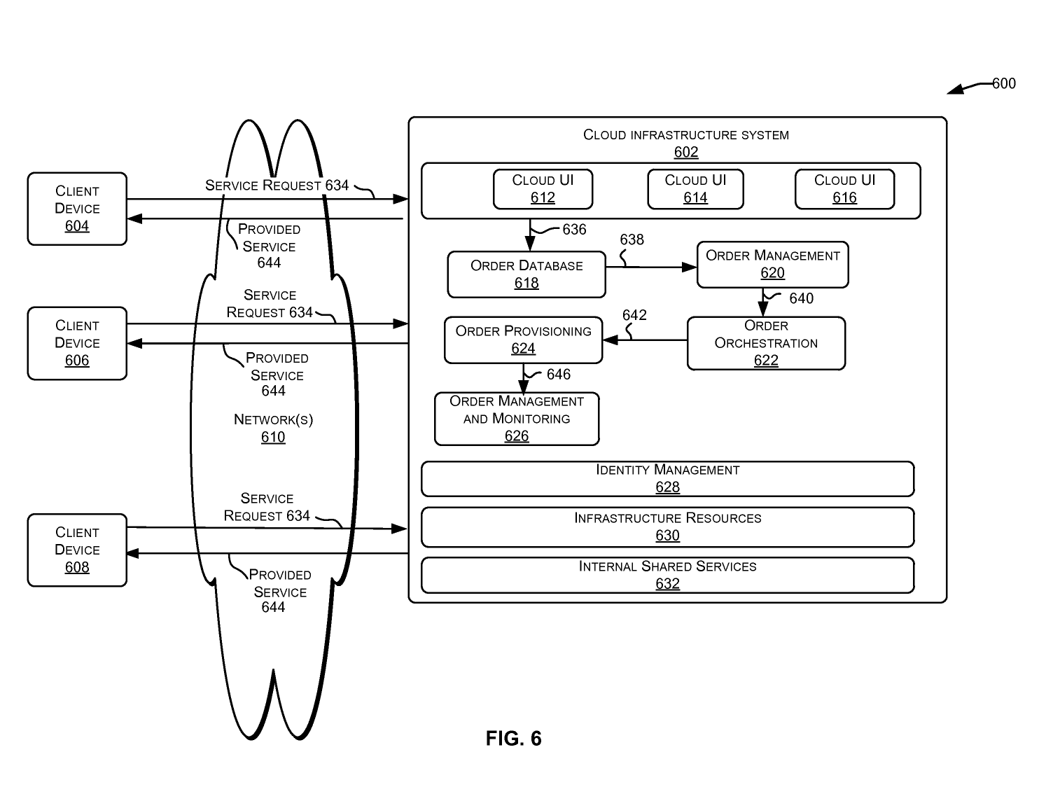

FIG. 6 is a simplified block diagram of one or more components of a system environment 600 by which services provided by one or more components of an embodiment system may be offered as cloud services, in accordance with an embodiment of the present disclosure. In the illustrated embodiment, system environment 600 includes one or more client computing devices 604, 606, and 608 that may be used by users to interact with a cloud infrastructure system 602 that provides cloud services. The client computing devices may be configured to operate a client application such as a web browser, a proprietary client application (e.g., Oracle Forms), or some other application, which may be used by a user of the client computing device to interact with cloud infrastructure system 602 to use services provided by cloud infrastructure system 602.

It should be appreciated that cloud infrastructure system 602 depicted in the figure may have other components than those depicted. Further, the embodiment shown in the figure is only one example of a cloud infrastructure system that may incorporate an embodiment of the invention. In some other embodiments, cloud infrastructure system 602 may have more or fewer components than shown in the figure, may combine two or more components, or may have a different configuration or arrangement of components.

Client computing devices 604, 606, and 608 may be devices similar to those described above for 502, 504, 506, and 508.

Although exemplary system environment 600 is shown with three client computing devices, any number of client computing devices may be supported. Other devices such as devices with sensors, etc. may interact with cloud infrastructure system 602.

Network(s) 610 may facilitate communications and exchange of data between clients 604, 606, and 608 and cloud infrastructure system 602. Each network may be any type of network familiar to those skilled in the art that can support data communications using any of a variety of commercially available protocols, including those described above for network(s) 510.

Cloud infrastructure system 602 may comprise one or more computers and/or servers that may include those described above for server 512.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 602 may include a suite of applications, middleware, and database service offerings that are delivered to a customer in a self-service, subscription-based, elastically scalable, reliable, highly available, and secure manner. An example of such a cloud infrastructure system is the Oracle Public Cloud provided by the present assignee.

In various embodiments, cloud infrastructure system 602 may be adapted to automatically provision, manage and track a customer's subscription to services offered by cloud infrastructure system 602. Cloud infrastructure system 602 may provide the cloud services via different deployment models. For example, services may be provided under a public cloud model in which cloud infrastructure system 602 is owned by an organization selling cloud services (e.g., owned by Oracle) and the services are made available to the general public or different industry enterprises. As another example, services may be provided under a private cloud model in which cloud infrastructure system 602 is operated solely for a single organization and may provide services for one or more entities within the organization. The cloud services may also be provided under a community cloud model in which cloud infrastructure system 602 and the services provided by cloud infrastructure system 602 are shared by several organizations in a related community. The cloud services may also be provided under a hybrid cloud model, which is a combination of two or more different models.

In some embodiments, the services provided by cloud infrastructure system 602 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 602. Cloud infrastructure system 602 then performs processing to provide the services in the customer's subscription order.

In some embodiments, the services provided by cloud infrastructure system 602 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations (such as Oracle) to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support. Examples of platform services include, without limitation, Oracle Java Cloud Service (JCS), Oracle Database Cloud Service (DBCS), and others.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services (e.g., Oracle Fusion Middleware services), and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 602 may also include infrastructure resources 630 for providing the resources used to provide various services to customers of the cloud infrastructure system. In one embodiment, infrastructure resources 630 may include pre-integrated and optimized combinations of hardware, such as servers, storage, and networking resources to execute the services provided by the PaaS platform and the SaaS platform.

In some embodiments, resources in cloud infrastructure system 602 may be shared by multiple users and dynamically re-allocated per demand. Additionally, resources may be allocated to users in different time zones. For example, cloud infrastructure system 630 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 632 may be provided that are shared by different components or modules of cloud infrastructure system 602 and by the services provided by cloud infrastructure system 602. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 602 may provide comprehensive management of cloud services (e.g., SaaS, PaaS, and IaaS services) in the cloud infrastructure system. In one embodiment, cloud management functionality may include capabilities for provisioning, managing, and tracking a customer's subscription received by cloud infrastructure system 602, and the like.

In one embodiment, as depicted in the figure, cloud management functionality may be provided by one or more modules, such as an order management module 620, an order orchestration module 622, an order-provisioning module 624, an order management and monitoring module 626, and an identity management module 628. These modules may include or be provided using one or more computers and/or servers, which may be general purpose computers, specialized server computers, server farms, server clusters, or any other appropriate arrangement and/or combination.

In exemplary operation 634, a customer using a client device, such as client device 604, 606 or 608, may interact with cloud infrastructure system 602 by requesting one or more services provided by cloud infrastructure system 602 and placing an order for a subscription for one or more services offered by cloud infrastructure system 602. In certain embodiments, the customer may access a cloud User Interface (UI), cloud UI 612, cloud UI 614 and/or cloud UI 616 and place a subscription order via these UIs. The order information received by cloud infrastructure system 602 in response to the customer placing an order may include information identifying the customer and one or more services offered by the cloud infrastructure system 602 that the customer intends to subscribe to.

After an order has been placed by the customer, the order information is received via the cloud UIs, 612, 614 and/or 616.

At operation 636, the order is stored in order database 618. Order database 618 can be one of several databases operated by cloud infrastructure system 618 and operated in conjunction with other system elements.

At operation 638, the order information is forwarded to an order management module 620. In some instances, order management module 620 may be configured to perform billing and accounting functions related to the order, such as verifying the order, and upon verification, booking the order.

At operation 640, information regarding the order is communicated to an order orchestration module 622. Order orchestration module 622 may utilize the order information to orchestrate the provisioning of services and resources for the order placed by the customer. In some instances, order orchestration module 622 may orchestrate the provisioning of resources to support the subscribed services using the services of order provisioning module 624.

In certain embodiments, order orchestration module 622 enables the management of business processes associated with each order and applies business logic to determine whether an order should proceed to provisioning. At operation 642, upon receiving an order for a new subscription, order orchestration module 622 sends a request to order provisioning module 624 to allocate resources and configure those resources needed to fulfill the subscription order. Order provisioning module 624 enables the allocation of resources for the services ordered by the customer. Order provisioning module 624 provides a level of abstraction between the cloud services provided by cloud infrastructure system 600 and the physical implementation layer that is used to provision the resources for providing the requested services. Order orchestration module 622 may thus be isolated from implementation details, such as whether or not services and resources are actually provisioned on the fly or pre-provisioned and only allocated/assigned upon request.

At operation 644, once the services and resources are provisioned, a notification of the provided service may be sent to customers on client devices 604, 606 and/or 608 by order provisioning module 624 of cloud infrastructure system 602.

At operation 646, the customer's subscription order may be managed and tracked by an order management and monitoring module 626. In some instances, order management and monitoring module 626 may be configured to collect usage statistics for the services in the subscription order, such as the amount of storage used, the amount data transferred, the number of users, and the amount of system up time and system down time.

In certain embodiments, cloud infrastructure system 600 may include an identity management module 628. Identity management module 628 may be configured to provide identity services, such as access management and authorization services in cloud infrastructure system 600. In some embodiments, identity management module 628 may control information about customers who wish to utilize the services provided by cloud infrastructure system 602. Such information can include information that authenticates the identities of such customers and information that describes which actions those customers are authorized to perform relative to various system resources (e.g., files, directories, applications, communication ports, memory segments, etc.) Identity management module 628 may also include the management of descriptive information about each customer and about how and by whom that descriptive information can be accessed and modified.

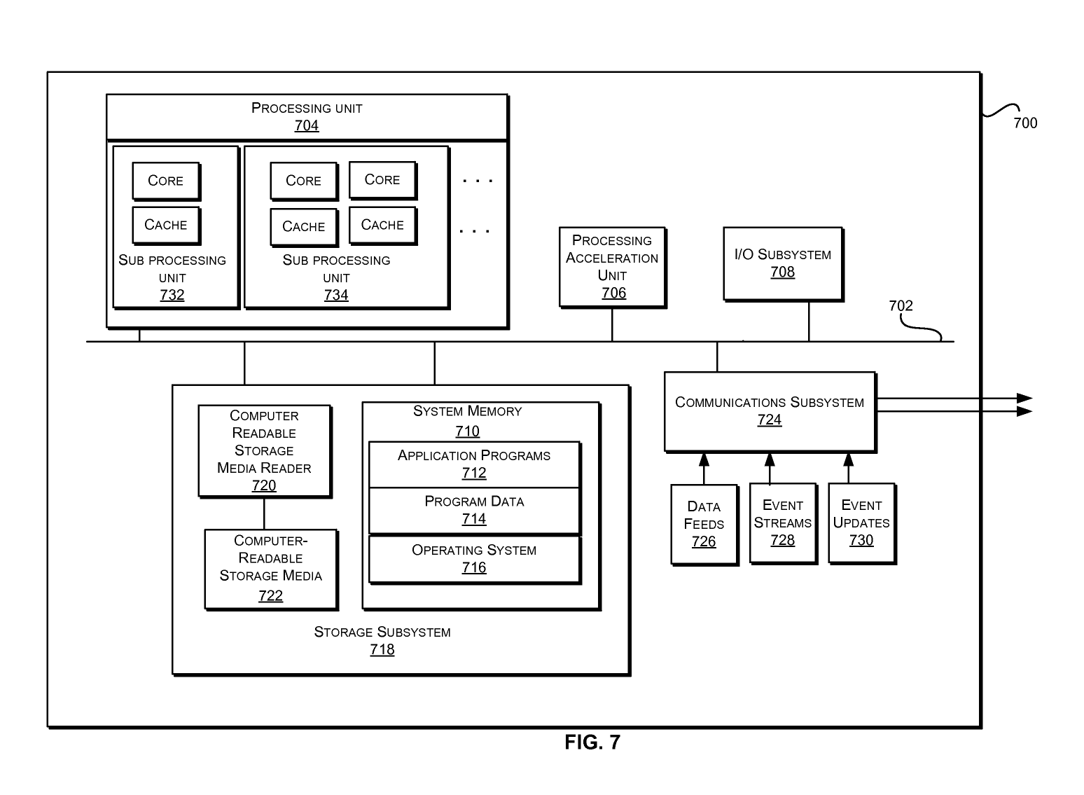

FIG. 7 illustrates an example computer system 700 in which various embodiments of the present invention may be implemented. The system 700 may be used to implement any of the computer systems described above. As shown in the figure, computer system 700 includes a processing unit 704 that communicates with a number of peripheral subsystems via a bus subsystem 702. These peripheral subsystems may include a processing acceleration unit 706, an I/O subsystem 708, a storage subsystem 718 and a communications subsystem 724. Storage subsystem 718 includes tangible computer-readable storage media 722 and a system memory 710.

Bus subsystem 702 provides a mechanism for letting the various components and subsystems of computer system 700 communicate with each other as intended. Although bus subsystem 702 is shown schematically as a single bus, alternative embodiments of the bus subsystem may utilize multiple buses. Bus subsystem 702 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus.

Processing unit 704, which can be implemented as one or more integrated circuits (e.g., a conventional microprocessor or microcontroller), controls the operation of computer system 700. One or more processors may be included in processing unit 704. These processors may include single core or multicore processors. In certain embodiments, processing unit 704 may be implemented as one or more independent processing units 732 and/or 734 with single or multicore processors included in each processing unit. In other embodiments, processing unit 704 may also be implemented as a quad-core processing unit formed by integrating two dual-core processors into a single chip.

In various embodiments, processing unit 704 can execute a variety of programs in response to program code and can maintain multiple concurrently executing programs or processes. At any given time, some or all of the program code to be executed can be resident in processor(s) 704 and/or in storage subsystem 718. Through suitable programming, processor(s) 704 can provide various functionalities described above. Computer system 700 may additionally include a processing acceleration unit 706, which can include a digital signal processor (DSP), a special-purpose processor, and/or the like.

I/O subsystem 708 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 700 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 700 may comprise a storage subsystem 718 that comprises software elements, shown as being currently located within a system memory 710. System memory 710 may store program instructions that are loadable and executable on processing unit 704, as well as data generated during the execution of these programs.

Depending on the configuration and type of computer system 700, system memory 710 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 704. In some implementations, system memory 710 may include multiple different types of memory, such as static random access memory (SRAM) or dynamic random access memory (DRAM). In some implementations, a basic input/output system (BIOS), containing the basic routines that help to transfer information between elements within computer system 700, such as during start-up, may typically be stored in the ROM. By way of example, and not limitation, system memory 710 also illustrates application programs 712, which may include client applications, Web browsers, mid-tier applications, relational database management systems (RDBMS), etc., program data 714, and an operating system 716. By way of example, operating system 716 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 7 OS, and Palm® OS operating systems.

Storage subsystem 718 may also provide a tangible computer-readable storage medium for storing the basic programming and data constructs that provide the functionality of some embodiments. Software (programs, code modules, instructions) that when executed by a processor provide the functionality described above may be stored in storage subsystem 718. These software modules or instructions may be executed by processing unit 704. Storage subsystem 718 may also provide a repository for storing data used in accordance with the present invention.

Storage subsystem 700 may also include a computer-readable storage media reader 720 that can further be connected to computer-readable storage media 722. Together and, optionally, in combination with system memory 710, computer-readable storage media 722 may comprehensively represent remote, local, fixed, and/or removable storage devices plus storage media for temporarily and/or more permanently containing, storing, transmitting, and retrieving computer-readable information.

Computer-readable storage media 722 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 700.

By way of example, computer-readable storage media 722 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 722 may include, but is not limited to, Zip® drives, flash memory cards, universal serial bus (USB) flash drives, secure digital (SD) cards, DVD disks, digital video tape, and the like. Computer-readable storage media 722 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 700.

Communications subsystem 724 provides an interface to other computer systems and networks. Communications subsystem 724 serves as an interface for receiving data from and transmitting data to other systems from computer system 700. For example, communications subsystem 724 may enable computer system 700 to connect to one or more devices via the Internet. In some embodiments communications subsystem 724 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 724 can provide wired network connectivity (e.g., Ethernet) in addition to or instead of a wireless interface.

In some embodiments, communications subsystem 724 may also receive input communication in the form of structured and/or unstructured data feeds 726, event streams 728, event updates 730, and the like on behalf of one or more users who may use computer system 700.

By way of example, communications subsystem 724 may be configured to receive data feeds 726 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 724 may also be configured to receive data in the form of continuous data streams, which may include event streams 728 of real-time events and/or event updates 730, which may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like. Communications subsystem 724 may also be configured to output the structured and/or unstructured data feeds 726, event streams 728, event updates 730, and the like to one or more databases that may be in communication with one or more streaming data source computers coupled to computer system 700.

Computer system 700 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 700 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

In the foregoing specification, aspects of the invention are described with reference to specific embodiments thereof, but those skilled in the art will recognize that the invention is not limited thereto. Various features and aspects of the above-described invention may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method comprising:
determining, by a computing device, one or more first points in a first metric time series that are outliers relative to other points in the first metric time series;
determining, by the computing device, one or more second points in a second metric time series that are outliers relative to other points in the second metric time series, wherein the points in the second metric time series differ from the points in the first metric time series;
removing, by the computing device, the one or more first points from the first metric time series to produce a first version of the first metric time series that lacks outliers;
removing, by the computing device, the one or more second points from the second metric time series to produce a first version of the second metric time series that lacks outliers;
determining, by the computing device, a first correlation coefficient based on the first version of the first metric time series and the first version of the second metric time series;
storing, by the computing device, the first correlation coefficient in association with the first metric time series and the second metric time series; and
accessing, by the computing device, the first correlation coefficient to quantify a possible relationship between the first metric time series and the second metric time series.

2. The method of claim 1, further comprising:
determining, by the computing device, a second correlation coefficient based on a second version of the first metric time series that contains the one or more first points and a second version of the second metric time series that contains the one or more second points; and
displaying, by the computing device, information that compares the first correlation coefficient to the second correlation coefficient.

3. The method of claim 1, further comprising:
segmenting a timeline into multiple time units;
after removing the one or more first points from the first metric time series and after removing the one or more second points from the second metric time series:
removing, from the first metric time series, points associated with timestamps that fall into time units into which no timestamp associated with a point from the second metric time series falls; and
removing, from the second metric time series, points associated with timestamps that fall into time units into which no timestamp associated with a point from the first metric time series falls.

4. The method of claim 3, further comprising:
for each particular time unit into which multiple points from the first metric time series fall, aggregating, into a single point, the multiple points that fall into the particular time unit.

5. The method of claim 4, wherein aggregating, into the single point, the multiple points that fall into the particular time unit comprises:
averaging non-timestamp values that are associated with the multiple points that fall into the particular time unit.

6. The method of claim 1, wherein determining the one or more first points in the first metric time series that are outliers relative to other points in the first metric time series comprises:
determining a point interval quantity based on a specified percentage of a total quantity of points in the first metric time series;
sorting points in the first metric time series by non-timestamp values associated with the points in the first metric time series, thereby producing a value-sorted series;
adding, to a set of point intervals, each set of adjacent points in the value-sorted series that includes a quantity of points equal to the point interval quantity;
selecting a representative point interval from the set of point intervals;
determining an upper bound based on a greatest value associated with a point from the representative point interval;
determining a lower bound based on a least value associated with a point from the representative point interval; and
determining the one or more first points in the first metric time series to be one or more points that are associated with values that are greater than the upper bound or lesser than the lower bound.

7. The method of claim 6, wherein selecting the representative point interval comprises:
determining, for each particular point interval in the set of point intervals, a difference between a greatest value associated with any point in the particular point interval and a least value associated with any point in the particular point interval;
determining a minimum difference that occurs among the differences determined for the point intervals in the set of point intervals; and
selecting the representative point interval from a subset of one or more point intervals that are each associated with the minimum difference;
wherein the greatest values and the least values are values based upon which the sorting of the points in the first metric time series was performed.

8. The method of claim 7, wherein selecting the representative point interval from the subset of one or more point intervals that are each associated with the minimum difference comprises:
selecting, from the subset of one or more point intervals that are each associated with the minimum difference, a first point interval that is most closely preceded by half of the points in the value-sorted series outside of the first point interval and that is most closely followed by half of the points in the value-sorted series outside of the first point interval.

9. The method of claim 1, further comprising:
sampling, over time, first values of an attribute of a component of a first user-specified subsystem of a cloud deployment;
associating the first values with points in the first metric time series;
sampling, over time, second values of an attribute of a component of a second user-specified subsystem of the cloud deployment;
associating the second values with points in the second metric time series; and
causing display, by the computing device, of the first correlation coefficient in response to a request to quantify the possible relationship between the first metric time series and the second metric time series.

10. A non-transitory computer-readable storage memory storing instructions which, when executed by one or more processors, cause the one or more processors to perform operations comprising:
Determining one or more first points in a first metric time series that are outliers relative to other points in the first metric time series;
determining one or more second points in a second metric time series that are outliers relative to other points in the second metric time series, wherein the points in the second metric time series differ from the points in the first metric time series;
removing the one or more first points from the first metric time series to produce a first version of the first metric time series that lacks outliers;
removing the one or more second points from the second metric time series to produce a first version of the second metric time series that lacks outliers;
determining a first correlation coefficient based on the first version of the first metric time series and the first version of the second metric time series;
storing the first correlation coefficient in association with the first metric time series and the second metric time series; and
accessing the first correlation coefficient to quantify a possible relationship between the first metric time series and the second metric time series.

11. The non-transitory computer-readable medium of claim 10, wherein the operations further comprise:
determining a second correlation coefficient based on a second version of the first metric time series that contains the one or more first points and a second version of the second metric time series that contains the one or more second points; and
displaying information that compares the first correlation coefficient to the second correlation coefficient.

12. The non-transitory computer-readable medium of claim 10, wherein the operations further comprise:
segmenting a timeline into multiple time units;
after removing the one or more first points from the first metric time series and after removing the one or more second points from the second metric time series:
removing, from the first metric time series, points associated with timestamps that fall into time units into which no timestamp associated with a point from the second metric time series falls; and
removing, from the second metric time series, points associated with timestamps that fall into time units into which no timestamp associated with a point from the first metric time series falls.

13. The non-transitory computer-readable medium of claim 12, wherein the operations further comprise:
for each particular time unit into which multiple points from the first metric time series fall, aggregating, into a single point, the multiple points that fall into the particular time unit.

14. The non-transitory computer-readable medium of claim 13, wherein aggregating, into the single point, the multiple points that fall into the particular time unit comprises:
averaging non-timestamp values that are associated with the multiple points that fall into the particular time unit.

15. The non-transitory computer-readable medium of claim 10, wherein determining the one or more first points in the first metric time series that are outliers relative to other points in the first metric time series comprises:
determining a point interval quantity based on a specified percentage of a total quantity of points in the first metric time series;
sorting points in the first metric time series by non-timestamp values associated with the points in the first metric time series, thereby producing a value-sorted series;
adding, to a set of point intervals, each set of adjacent points in the value-sorted series that includes a quantity of points equal to the point interval quantity;
selecting a representative point interval from the set of point intervals;
determining an upper bound based on a greatest value associated with a point from the representative point interval;
determining a lower bound based on a least value associated with a point from the representative point interval; and
determining the one or more first points in the first metric time series to be one or more points that are associated with values that are greater than the upper bound or lesser than the lower bound.

16. The non-transitory computer-readable medium of claim 15, wherein selecting the representative point interval comprises:
determining, for each particular point interval in the set of point intervals, a difference between a greatest value associated with any point in the particular point interval and a least value associated with any point in the particular point interval;
determining a minimum difference that occurs among the differences determined for the point intervals in the set of point intervals; and
selecting the representative point interval from a subset of one or more point intervals that are each associated with the minimum difference;
wherein the greatest values and the least values are values based upon which the sorting of the points in the first metric time series was performed.

17. The non-transitory computer-readable medium of claim 16, wherein selecting the representative point interval from the subset of one or more point intervals that are each associated with the minimum difference comprises:
selecting, from the subset of one or more point intervals that are each associated with the minimum difference, a first point interval that is most closely preceded by half of the points in the value-sorted series outside of the first point interval and that is most closely followed by half of the points in the value-sorted series outside of the first point interval.

18. The non-transitory computer-readable medium of claim 10, wherein the operations further comprise:
sampling, over time, first values of an attribute of a component of a first user-specified subsystem of a cloud deployment;
associating the first values with points in the first metric time series;
sampling, over time, second values of an attribute of a component of a second user-specified subsystem of the cloud deployment;
associating the second values with points in the second metric time series; and
causing display of the first correlation coefficient in response to a request to quantify the possible relationship between the first metric time series and the second metric time series.

19. A system comprising:
one or more processors; and
a computer-readable memory storing instructions executable by the one or more processors to cause the one or more processors to perform operations comprising:
determining one or more first points in a first metric time series that are outliers relative to other points in the first metric time series;
determining one or more second points in a second metric time series that are outliers relative to other points in the second metric time series, wherein the points in the second metric time series differ from the points in the first metric time series;
removing the one or more first points from the first metric time series to produce a first version of the first metric time series that lacks outliers;
removing the one or more second points from the second metric time series to produce a first version of the second metric time series that lacks outliers;
determining a first correlation coefficient based on the first version of the first metric time series and the first version of the second metric time series;
storing the first correlation coefficient in association with the first metric time series and the second metric time series; and
accessing the first correlation coefficient to quantify a possible relationship between the first metric time series and the second metric time series.

20. The system of claim 19, wherein the operations further comprise:
determining a second correlation coefficient based on a second version of the first metric time series that contains the one or more first points and a second version of the second metric time series that contains the one or more second points; and
displaying information that compares the first correlation coefficient to the second correlation coefficient.
